(19) United States
(12) Patent Application Publication
(10) Pub. No.: US 2012/0125596 A1
(43) Pub. Date: May 24, 2012

(54) RUGGEDIZED FIBER OPTIC CABLE AND METHOD OF OPTICAL FIBER TRANSMISSION

(75) Inventors: Daniel S. Homa, Blacksburg, VA (US); Robert M. Harman, Troutville, VA (US); Alan C. Reynolds, Windsor, VA (US)

(73) Assignee: BAKER HUGHES INCORPORATED, Houston, TX (US)

(21) Appl. No.: 13/182,736

(22) Filed: Jul. 14, 2011

Related U.S. Application Data
(60) Provisional application No. 61/275,721, filed on Nov. 24, 2010.

(51) Int. Cl. E21B 47/00; G02B 6/44

(52) U.S. Cl. 166/66; 385/100

(57) ABSTRACT

A fiber optic cable includes: a first elongated body, the first elongated body having a longitudinal axis; an elongated sleeve disposed coaxially with the first elongated body, the elongated sleeve including a plurality of second elongated bodies wrapped around an exterior surface of the first elongated body; and at least one elongated fiber optic component disposed inside of and coaxially with at least one of the first elongated body and a second elongated body.

### CROSS-REFERENCE TO RELATED APPLICATIONS AND PRIORITY CLAIM

This application claims the benefit of U.S. Provisional Application Ser. No. 61/275,721, entitled “RUGGEDIZED FIBER OPTIC CABLE AND METHOD OF OPTICAL FIBER TRANSMISSION”, filed Nov. 24, 2010, under 35 U.S.C. §119(e), which is incorporated herein by reference in its entirety.

### BACKGROUND

Optical fibers find use in a variety of applications. For example, in the drilling and completion industry, optical fibers find use as both communication media and sensing media for measuring various downhole parameters and operation parameters. Optical fibers can be incorporated in protective cables to protect the fibers from downhole conditions. Features that are significant in fiber optic cables include handlability, ability to protect the fibers from high temperatures and pressures, and resistance to bending.

### SUMMARY OF THE INVENTION

A fiber optic cable includes: a first elongated body, the first elongated body having a longitudinal axis; an elongated sleeve disposed coaxially with the first elongated body, the elongated sleeve including a plurality of second elongated bodies wrapped around an exterior surface of the first elongated body; and at least one elongated fiber optic component disposed inside of and coaxially with at least one of the first elongated body and a second elongated body.

A downhole system includes: a carrier configured to be disposed within a borehole in an earth formation; and fiber optic cable in operable communication with the carrier, the fiber optic cable including: a first elongated body, the first elongated body having a longitudinal axis; an elongated sleeve disposed coaxially with the first elongated body, the elongated sleeve including a plurality of second elongated bodies wrapped around an exterior surface of the first elongated body; and at least one elongated fiber optic component disposed inside of and coaxially with at least one of the first elongated body and a second elongated body.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an axial cross-sectional view of an embodiment of a fiber optic cable including a central elongated body and a sleeve including a plurality of metallic strands;

FIG. 2 is an axial cross-sectional view of another embodiment of the fiber optic cable of FIG. 1;

FIG. 3 is an axial cross-sectional view of another embodiment of the fiber optic cable of FIG. 1;

FIG. 4 is an axial cross-sectional view of an embodiment of the fiber optic cable of FIG. 1, in which at least one of the plurality of strands includes an optical fiber therein;

FIG. 5 is an axial cross-sectional view of another embodiment of the fiber optic cable of FIG. 4;

FIG. 6 is an axial cross-sectional view of another embodiment of the fiber optic cable of FIG. 4; and

FIG. 7 is a side cross-sectional view of an embodiment of a downhole drilling, completion and/or measurement system.

### DETAILED DESCRIPTION

There are provided fiber optic cables and systems for utilizing fiber optic cables in a downhole environment. An exemplary fiber optic cable includes one or more fiber optic components such as optical fibers and optical fiber bundles, an elongated central body, and a coaxial elongated sleeve surrounding the central elongated body. The sleeve includes a plurality of peripheral elongated bodies wrapped around an exterior surface of the central elongated body. For example, the cable includes a central steel tube and the sleeve includes a plurality of steel tubes or strands wrapped around the central tube in a braided or spiral configuration. In one embodiment, the central body is a hollow central tube and one or more fiber optic components are disposed coaxially with the central tube and in an interior of the central tube. In one embodiment, one or more fiber optic components are disposed coaxially with and in an interior of one or more of the peripheral strands. The central body and/or peripheral strands may also include other components such as electrical conductors. In one embodiment, the sleeve is surrounded by an outer tubular body. The optical fibers disposed in the cable may be any type of fiber device, such as optical fiber sensors and communication fibers.

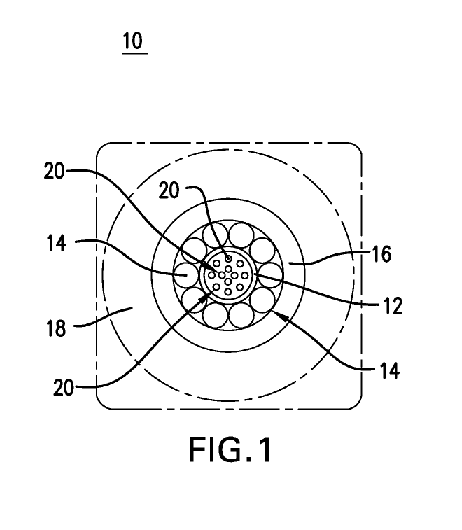

Referring to FIG. 1, an embodiment of a fiber optic cable 10 includes a first elongated body such as a central tube 12 and a plurality of second elongated bodies such as strands 14 wrapped around the central tube 12 and forming a sleeve around the exterior surface of the central tube 12. The strands 14 are distributed around the periphery of the central tube 12, and in one embodiment are wrapped in a helical path around the outer surface of the central tube 12. The strands 14 may be disposed around the central tube 12 in any suitable configuration, such as coaxially with the longitudinal axis of the central tube 12 or as a braided sleeve. In one embodiment, the central tube 12 and the strands 14 are disposed inside a protective outer tube 16. Additional outer components such as a cable jacket 18 may also be included as part of the cable 10. The outer tubes 16 and 18 may be selected based on the environment in which the cable is to be deployed, and be made of materials selected to withstand, for example, elevated temperatures and pressures experienced in a downhole environment.

In one embodiment, the central tube 12 is a hollow body and includes one or more optical fibers 20 disposed coaxially with and inside the central tube 12. The optical fibers 20 may be configured as optical fiber sensors such as sensors including multiple Bragg gratings or other scattering and/or sensing locations, temperature sensors such as distributed temperature sensing (DTS) sensors, seismic sensors, acoustic sensors, pressure sensors, strain sensors and others. The optical fibers 20 may also be configured as communication fibers, fiber bundles or any other optical fiber devices. In the example shown in FIG. 1, the optical fibers 20 are encased in a stabilizing or protective material such as a gel 22 or other cable filling material. In one embodiment, interstitial spaces or interstices formed between optical fibers 20 in the central tube and/or between the strands 14 are filled with a stabilizing or filling material. Examples of such materials include liquids, gels, liquid metals and gases such as selected gas mixtures and/or inert gases. Other examples of interstitial materials include polymers such as epoxies and plastics. Further examples include flowable solids such as silica particulates (e.g., natural or synthetic sand), microparticles and nanoparticles. The optical fibers 20 may include single mode and/or multi-mode fibers. In one embodiment, the optical fibers 20 are protectively coated such as with a carbon coating to improve hydrogen resistance.

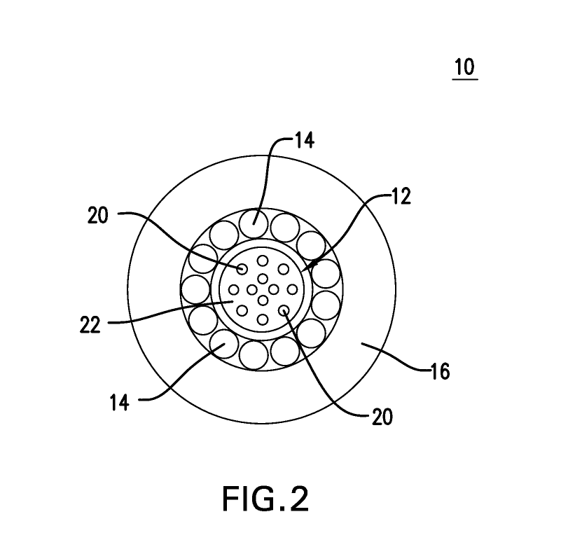

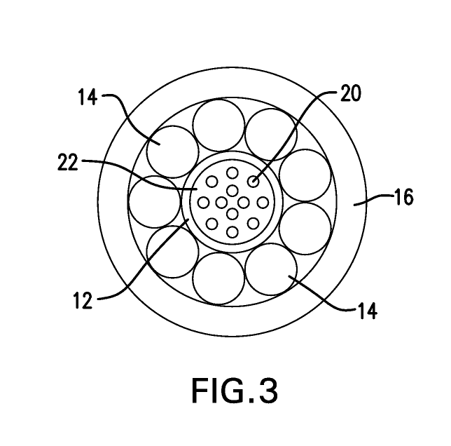

FIGS. 1-3 illustrate non-limiting examples of the cable 10. FIG. 1 shows a cable 10 including an inner central tube 12 made from a metallic material such as SAE (Society of Automotive Engineers) grade 304 stainless steel and having an approximately 0.008 inch wall thickness. The strands 14 are made from a metallic material such as a higher strength stainless steel and are helically wrapped around the central tube 12. The strands have a diameter of approximately 0.040 inch, for example. The central tube 12 and the strands 14 are, for example, encapsulated in an outer metal tube 16 made from a material such as SAE grade 316I stainless steel or an alloy such as alloy 825 and alloy 625, and having an exemplary thickness of about 0.035 inch thick. The outer tube 16 has an outer diameter of, for example, about 0.25 inch to about 1 inch, for example. FIG. 2 shows an example of a cable 10 having a relatively thick-walled outer tube 16 (e.g., an about 0.25 inch outer diameter and an about 0.049 inch wall thickness) that may be useful, for example, for abrasion resistance. FIG. 3 shows an example of a cable 10 having a relatively thin-walled outer tube 16 (e.g., an about 0.25 inch outer diameter and an about 0.028 inch wall thickness) that may be useful, for example, as part of a coaxial cable.

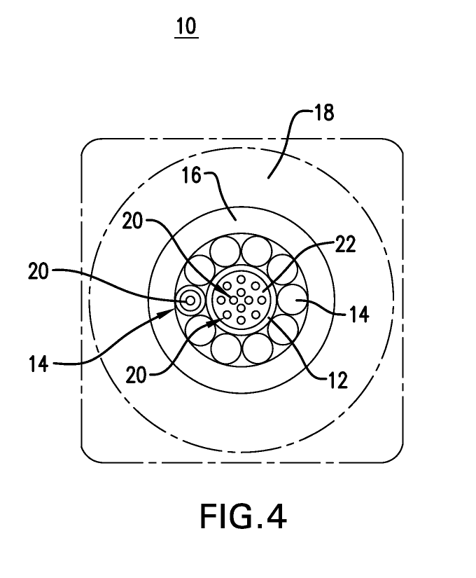

Referring to FIGS. 4-6, in one embodiment, one or more of the strands 14 are configured as a tubular body that is hollow or otherwise includes a passageway to allow an optical fiber component such as an optical fiber 20 to be disposed coaxially with and inside the strand 14. For example, referring to FIG. 4, the cable 10 includes a hollow central tube 12 having gel encapsulated optical fibers 20 disposed therein and a plurality of metal strands 14 wrapped helically around the central tube 12. In this example, at least one of the strands is a hollow tube having one or more optical fibers 20 disposed coaxially therein. An exemplary strand 14 is a stainless steel tube having an outer diameter of about 0.0040 inch and a wall thickness of about 0.008 inch. The dimensions, configurations and composition of the strands 14 are merely exemplary, as the strands may be wrapped around the central tube 12 in any suitable configuration and have any suitable thickness or other dimensions. In addition, the strands 14 may be hollow or solid strands made from various materials such as metals (e.g., steel or aluminum), polymers such as plastics and polyimides, and/or ceramic materials. One or more of the strands 14, in one embodiment, is a waveguide component such as an optical fiber, optical fiber bundle or one or more glass rods or elongated members such as fused silica canes.

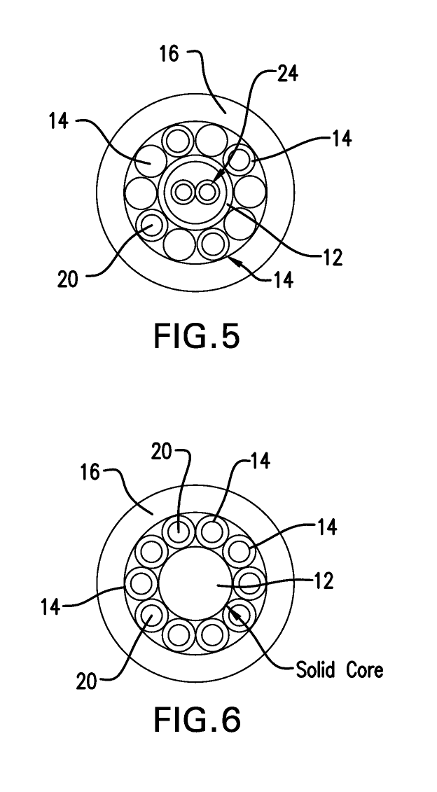

In another example shown in FIG. 5, a plurality of the strands 14 include optical fibers 20 disposed therein. FIG. 5 also illustrates another embodiment of the central tube 12 having one or more electrical conductors 24 such as copper wires. In this example, the conductors 24 are configured as twisted pairs, but are not so limited.

FIG. 6 illustrates an embodiment of the cable 10 in which all of the strands 14 are hollow strands including optical fibers 20. The central tube 12 may be a solid tube, for example, to add strength to the cable 10.

In one embodiment, one or more of the conductors 24 are hollow tubes and include one or more optical fibers 20 disposed therein. In one embodiment, one or more of the strands 14 are made from copper or another conductive materials and act as a conductor. In one example, one or more electrically conductive strands 14 are hollow tubes and include one or more optical fibers 20.

The dimensions and materials of the central body 12, the strands 14 and the outer tubes 16 and 18 are merely exemplary. The components described herein may be made from any suitable materials, such as steel or stainless steel, and including but not limited to the materials described in the embodiments herein. For example, the strands can be made from steel, stainless steel, lead, aluminum, copper or other materials.

The components of the cable 10 are not limited to the specific embodiments described herein. For example, the central tube 12 may be a single tube or a plurality of tubes, and may be solid, hollow or have various bores or passageways therein. In addition, the strands 14 may have any suitable thickness or number of strands wrapped around the central tube 12. The strands 14 may also be solid or have passageways therein.

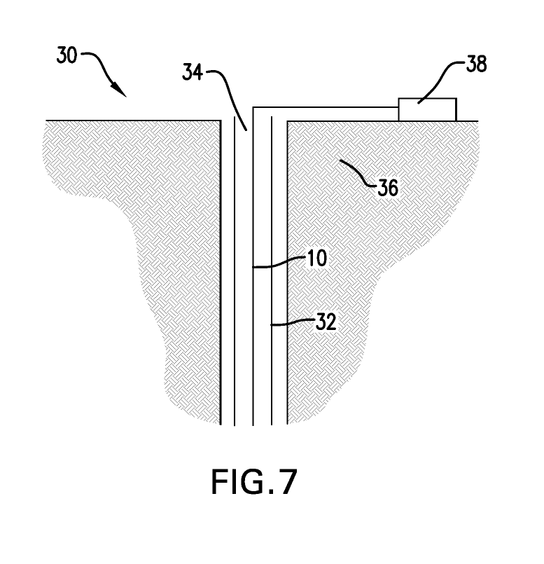

Referring to FIG. 7, a downhole drilling, completion and/or measurement system 30 includes a fiber optic sensing and/or communication assembly having at least one fiber optic cable 10. The system 30 may be used in conjunction with various downhole systems and components and includes a carrier such as a borehole string 32 (e.g., a drillstring or production string) disposed in a borehole 34 in an earth formation 36. The cable 10 may be deployed with a component such as the downhole string 32, or may be deployed with a borehole casing. The cable 10 may be configured to provide sensor information and/or communication between downhole components and, for example, a surface processing unit 38. The surface processing unit 38 includes one or more processing devices configured to collect and/or analyze data, and/or control downhole components. In one example, the cable 10 is part of a downhole sensing assembly and the surface processing unit 38 is configured to transmit interrogation signals into the cable 10, receive return signals indicative of a downhole parameter (e.g., temperature) and/or process the return signals. The processing units 38 described herein are not restricted to surface locations, and may be positioned at various downhole locations.

The measurement system 30 is not limited to that described herein. The cable 10 may be deployed and/or disposed in the borehole 14 via any suitable carrier. A “carrier” as described herein means any device, device component, combination of devices, media and/or member that may be used to convey, house, support or otherwise facilitate the use of another device, device component, combination of devices, media and/or member. Exemplary non-limiting carriers include borehole strings of the coiled tube type, of the jointed pipe type and any combination or portion thereof. Other carrier examples include casing pipes, wirelines, wireline sondes, slickline sondes, drop shots, downhole subs, bottom-hole assemblies, and drill strings.

There is provided a method of measuring an environmental or component parameter and/or communicating between components in a downhole system using a fiber optic cable such as the cable 10. In a first stage, the cable 10 is deployed in the borehole 34 via the borehole string 32 and/or via other components, such as a drilling assembly or measurement sub. In a second stage, one or more signals are transmitted between components in the downhole system 30. For example, communication signals are sent between downhole components and the surface processing unit 38 via the cable 10 for exchanging data and/or controlling downhole components. In another example, interrogation signals are transmitted into the cable 10 from the surface processing unit 38, and measurement locations such as Bragg gratings or Rayleigh scattering sections of one or more optical fibers 20 reflect signals indicative of parameters such as temperature.

The apparatuses and methods described herein provide various advantages over existing methods and devices. The fiber optic cables described herein are both mechanically and optically robust, allowing multiple fiber optic devices to be deployed in a cable for various purposes. Such cables also exhibit improved bend resistance and handlability. In addition, the cables described herein are more rugged and are less limited by temperature and may also require fewer protective jackets or other components.

In connection with the teachings herein, various analyses and/or analytical components may be used, including digital and/or analog systems. The apparatus may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

1. A fiber optic cable comprising:
a first elongated body having a longitudinal axis;
an elongated sleeve disposed coaxially with the first elongated body, the elongated sleeve including a plurality of second elongated bodies wrapped around an exterior surface of the first elongated body; and
one or more elongated fiber optic components disposed inside of and coaxially with at least one of the first elongated body and a second elongated body.

2. The fiber optic cable of claim 1, wherein the first elongated body is a hollow tube including the one or more elongated fiber optic components disposed therein.

3. The fiber optic cable of claim 2, wherein the first elongated body includes a plurality of elongated fiber optic components disposed coaxially therein.

4. The fiber optic cable of claim 2, further comprising a filling material disposed in at least one of: interstitial spaces between each of the one or more elongated fiber optic components, interstitial spaces between the one or more elongated fiber optic components and the hollow tube, and interstitial spaces in the elongated sleeve.

5. The fiber optic cable of claim 4, wherein the filling material includes at least one of a liquid, a gel, a gas, a polymer material and a flowable solid material.

6. The fiber optic cable of claim 1, wherein at least one of the plurality of second elongated bodies is a hollow tube including at least one fiber optic component disposed therein.

7. The fiber optic cable of claim 6, wherein the first elongated body is a solid body.

8. The fiber optic cable of claim 1, wherein at least one of the plurality of second elongated bodies includes at least one of an electrically conductive material, a polymer material and a ceramic material.

9. The fiber optic cable of claim 1, wherein the plurality of second elongated bodies are wrapped in at least one of a helical configuration and a braided configuration.

10. The fiber optic cable of claim 1, wherein at least one of the plurality of second elongated bodies include at least one of an optical fiber and a glass material.

11. The fiber optic cable of claim 1, wherein at least one of the first elongated body and the plurality of second elongated bodies includes an electrical conductor.

12. The fiber optic cable of claim 1, further comprising a metallic outer tubular body encapsulating the first elongated body and the elongated sleeve.

13. The fiber optic cable of claim 1, wherein the at least one fiber optic component includes an optical fiber configured for at least one of sensing and communication.

14. The fiber optic cable of claim 1, wherein at least one of the first elongated body and the plurality of second elongated bodies are made from one or more metallic materials.

15. A downhole system comprising:
a carrier configured to be disposed within a borehole in an earth formation; and
a fiber optic cable in operable communication with the carrier, the fiber optic cable including:
a first elongated body, the first elongated body having a longitudinal axis;
an elongated sleeve disposed coaxially with the first elongated body, the elongated sleeve including a plurality of second elongated bodies wrapped around an exterior surface of the first elongated body; and
at least one elongated fiber optic component disposed inside of and coaxially with at least one of the first elongated body and a second elongated body.

16. The system of claim 15, wherein the at least one fiber optic component includes an optical fiber configured for at least one of sensing and communication.

17. The system of claim 15, further comprising a processing unit in operable communication with the at least one fiber optic component and configured to receive signals from the at least one fiber optic component.

18. The system of claim 17, wherein the processing unit includes an electromagnetic source configured to transmit an interrogation signal and receive a measurement signal from the at least one fiber optic component.

19. The system of claim 15, wherein the first elongated body is a hollow tube including the at least one elongated fiber optic component disposed therein.

20. The system of claim 15, wherein at least one of the plurality of second elongated bodies is a hollow tube including at least fiber optic component disposed therein.
